(19) United States
(12) Patent Application Publication
(10) Pub. No.: US 2024/0322531 A1
(43) Pub. Date: Sep. 26, 2024

(54) ELECTRICALLY INSULATING ROTARY GRIP-ALL CLAMP STICK HAVING DOUBLE PAWL OPERATION UNIT FOR INDIRECT HOT-LINE WORK, AND METHOD FOR OPERATING INDIRECT HOT-LINE TOOL MECHANISM USING SAME

(71) Applicants: DAEWON ELECTRIC CO., LTD., Cheongju-si, Chungcheongbukdo (KR); DAEWON INDUSTRY CORP., Jeungpyeong-gun, Chungcheongbuk-do (KR)

(72) Inventor: Se Won KWON, Jeungpyeong-gun (KR)

(73) Assignees: DAEWON ELECTRIC CO., LTD., Cheongju-si, Chungcheongbukdo (KR); DAEWON INDUSTRY CORP., Jeungpyeong-gun, Chungcheongbuk-do (KR)

(21) Appl. No.: 18/575,433

(22) PCT Filed: Apr. 27, 2022
(86) PCT No.: PCT/KR2022/005995

§ 371 Date: Dec. 29, 2023

(30) Foreign Application Priority Data
Jul. 1, 2021 (KR) 10-2021-0086646

(51) Int. Cl. H02G 1/04; B25B 5/04; B25B 5/14; B25B 7/12

(52) U.S. Cl. CPC H02G 1/04; B25B 5/04; B25B 5/14; B25B 7/12

(57) ABSTRACT

An electrically insulating rotary grip-all clamp stick having a double pawl operation unit for indirect hot-line work, and a method for operating an indirect hot-line tool mechanism using the clamp stick. The clamp stick is configured such that the operation unit is constituted by using a rack and a pinion gear so that a worker can safely and conveniently perform hot-line work or uninterruptible power work. A holder part and a hook assembly are operated by the operation unit, so that a tip tool can be solidly coupled to the holder part. Since a length of the operation unit is minimized, the worker can easily hold and operate the tip tool when the worker operates the tip tool, or performs work for removing a bind wire of a rotary wound-drawn type ultra-high-voltage distribution line or removing foreign substances including a layer coating an electric wire.

### TECHNICAL FIELD

The present disclosure relates to a clamp stick used for hot-line work. More specifically, the present disclosure relates to an electrically insulating rotary grip-all clamp stick having a double pawl operation unit for indirect hot-line work, and relates to a method for operating an indirect hot-line tool mechanism using the electrically insulating rotary grip-all clamp stick, the electrically insulating rotary grip-all clamp stick being configured such that the double pawl operation unit is constituted by using a rack and a pinion gear so that a worker is capable of safely and more performing conveniently hot-line work or uninterruptible power work while supplying of electricity is not stopped. Furthermore, a holder part and a hook assembly are configured to be operated by the double pawl operation unit, so that a tip tool is capable of being solidly coupled to a tip of the holder part. Furthermore, since a length of the double pawl operation unit is minimized, the worker is capable of easily holding and operating the tip tool when the worker operates the tip tool, performs work for removing a bind wire of a rotary wound-drawn type ultra-high-voltage distribution line, or performs work for removing foreign substances including a layer coating an electric wire.

### BACKGROUND ART

Generally, hot-line work refers to line work performed while electric power transmission is continuously performed on an electric power distribution line. Since performing the hot-line work has a high risk of safety accidents, the hot-line work is performed when it is difficult to cut off electric power, such as in power transmission and distribution facilities. Therefore, a user performing the hot-line work must use an insulating protective device or insulating protective gear.

Hot-line work of an electric power distribution line may be divided into direct hot-line work and indirect hot-line work. The direct hot-line work is a method in which a user located inside an insulated bucket performs direct contact work after the user puts on insulating gloves during a hot-line state. While the direct hot-line work has advantages that the direct hot-line work can be performed easily and work time can be saved, the direct hot-line work has disadvantages that there is a high risk of electric shock which often results in casualties. The indirect hot-line work is a method in which a user performs indirect hot-line work by using insulating tools such as a hot stick and so on. The indirect hot-line work requires a lot of work time, but a risk of safety accidents can be greatly reduced.

Hot-line work may include work for checking a component such as an insulator constituting an electric wire line, work for repairing the same, work for replacing the same, work for cleaning the same, and so on. Furthermore, direct hot-line work or indirect hot-line work may be appropriately used according to the type of work.

Recently, in performing new installation work or maintenance work of an electric power distribution line, a proportion of hot-line work or uninterruptible power work in which supplying of electricity is not cut off during performing work is increasing. Conventionally, there have been a lot of direct hot-line work in which a user directly contacts a high-voltage electric power line. However, currently, for safety reasons, a work method is changing from direct hot-line work to non-contact indirect hot-line work.

In order for realizing indirect hot-line work, a corresponding work tool for the indirect hot-line work is required. However, there is a problem that tools distributed conventionally can only be used for a small portion of indirect hot-line work, and there is a problem that safety is reduced since the tools are outdated tools that are not suitable for the current working environment.

### DISCLOSURE

### Technical Problem

Accordingly, the present disclosure has been made keeping in mind the above problems occurring in the related art, and an objective of the present disclosure is to provide an electrically insulating rotary grip-all clamp stick having a double pawl operation unit for indirect hot-line work, and to provide a method for operating an indirect hot-line tool mechanism using the electrically insulating rotary grip-all clamp stick, the electrically insulating rotary grip-all clamp stick being configured to be easily operated and to be conveniently used so that a worker is capable of safely and conveniently performing work on increasingly complex electric power distribution lines and indirect hot-line work. Particularly, in the double pawl operation unit, a rack and pinion gear are provided in a hollow of the operation knob such that a length of the double pawl operation unit is capable of being minimized, so that the worker is capable of easily holding and operating a tip tool when the worker couples the tip tool to the clamp stick, operates the tip tool, performs work for removing a bind wire of a rotary wound-drawn type ultra-high-voltage distribution line, or performs work for removing foreign substances including a layer coating an electric wire.

### Technical Solution

In order to achieve the objectives as described above, in the present disclosure, there is provided an electrically insulating rotary grip-all clamp stick having a double pawl operation unit for indirect hot-line work, the clamp stick being configured to clamp a work object by using a hook assembly inserted into a holder part or being configured to rotate the clamped work object by rotating the holder part by using an electric handle connected to the holder part through an insulating rod part, the clamp stick including: an operation rod mounted such that the operation rod passes through a hollow of the insulating rod part, the operation rod being mounted such that a front side of the operation rod is connected to a rear side of the hook assembly; and the double pawl operation unit mounted on a rear side of the insulating rod part, the double pawl operation unit being mounted such that the double pawl operation unit is connected to a rear side of the operation rod, and the double pawl operation unit being configured to adjust a depth at which the hook assembly is inserted into the holder part.

In addition, the double pawl operation unit of the present disclosure may include: an extension rod part mounted on the rear side of the insulating rod part, the extension rod part having a hollow; an operation knob having a hollow, the operation knob being mounted on an outer circumference of the extension rod part such that the operation knob is capable of being moved in front and rear directions; a lower rack gear having a length in the front and rear directions, the lower rack gear being mounted in the hollow of the extension rod part, and the lower rack gear being mounted such that the lower rack gear is connected to the rear side of the operation rod; a pinion part mounted on a rear side of the extension rod part, the pinion part being mounted in the hollow of the operation knob, having a hollow formed such that a rear side of the lower rack gear passes therethrough, and having a pinion gear which corresponds to the lower rack gear and which is provided on an upper portion of the lower rack gear; and an upper rack gear having a length in the front and rear directions, the upper rack gear being fixedly mounted in the hollow of the operation knob, being fixedly mounted such that the upper rack gear is positioned on an upper portion of the pinion part, corresponding to the pinion gear, and being configured to be moved in a direction same as a movement direction of the lower rack gear by the pinion gear.

In addition, the double pawl operation unit of the present disclosure may include a ratchet plate fixedly mounted on the outer circumference of the extension rod part, the ratchet plate being fixedly mounted such that the ratchet plate is positioned on a lower portion of the upper rack gear, and the ratchet plate having a pair of ratchet gears formed on an upper surface of the ratchet plate along the front and rear directions such that the ratchet gears are positioned on opposite sides of the upper rack gear. Furthermore, the operation knob of the present disclosure may include a first pawl mounted such that the first pawl passes through an upper front side of the operation knob, the first pawl being mounted such that the first pawl corresponds to the ratchet gears.

In addition, the pinion part of the present disclosure may include: a body coupled to the rear side of the extension rod part, the body having an open upper portion of an outer circumference thereof, and the body having a hollow such that the rear side of the lower rack gear passes therethrough; and a pair of pinion support bodies formed on opposite sides of the open upper portion of the body, the pinion support bodies being provided such that the pinion gear is capable of being rotated.

In addition, the upper rack gear of the present disclosure may include a guide groove formed in a longitudinal direction on both side surfaces of the upper rack gear, and the pinion support bodies of the pinion part may include respective guide protrusions which protrude on upper inner side surfaces of the pinion support bodies and which are inserted into the guide groove.

In addition, the pinion part of the present disclosure may include a bearing part mounted in a lower portion of the hollow of the body, thereby supporting a lower surface of the lower rack gear.

In addition, the ratchet plate of the present disclosure may include a locking ratchet formed on a front side of the upper surface of the ratchet plate and formed between the pair of ratchet gears, and the operation knob may include a second pawl mounted such that the second pawl passes through the upper front side of the operation knob, the second pawl being mounted such that the second pawl passes through a center of the first pawl, and the second pawl corresponding to the locking ratchet.

In addition, the insulating rod part of the present disclosure may include: a rotating pipe having a hollow, the rotating pipe being mounted on an outer circumference of the operation rod, and the rotating pipe being mounted such that a front side of the rotating pipe is connected to a rear side of the holder part; and a support pipe body having a hollow, the support pipe body being mounted on an outer circumference of the rotating pipe, and the support pipe body being mounted such that the holder part is connected to a front side of the support pipe body so that the holder part is capable of being rotated. Furthermore, the electric handle of the present disclosure may include: a power transmission part mounted between a rear side of the support pipe body and a front side of the double pawl operation unit, the power transmission part being mounted such that a power is capable of being transmitted between the rotating pipe and the electric handle, and the power transmission part being configured such that the power transmission part passes through the rear side of the operation rod; a handle body mounted on an upper portion of the power transmission part and provided with a driving motor; and a rotation prevention member mounted inside the power transmission part, the rotation prevention member being configured to prevent a rotation of the rotating pipe when the handle body is separated from the power transmission part.

In addition, the power transmission part of the present disclosure may include: a gear housing mounted between the rear side of the support pipe body and the front side of the double pawl operation unit; a first bevel gear mounted on a front inner side of the gear housing and connected to a rear side of the rotating pipe; and a second bevel gear 156c mounted on an upper inner side of the gear housing, the second bevel gear 156c corresponding to the first bevel gear, and the second bevel gear 156c having a coupling hole formed through the second bevel gear 156c. Furthermore, the rotation prevention member of the present disclosure may include: a lower support body mounted on a lower inner side of the gear housing; and an upper support body 158b mounted on an upper portion of the lower support body such that the upper support body 158b is elastically supported in an upward direction, the upper support body 158b being provided with a rotation prevention protrusion which is inserted into the coupling hole of the second bevel gear 156c and which is configured to prevent a rotation of the second bevel gear 156c.

In order to achieve the objectives as described above, in the present disclosure, there is provided a method for operating an indirect hot-line tool mechanism using an electrically insulating rotary grip-all clamp stick having a double pawl operation unit for indirect hot-line work, the clamp stick being configured to clamp a work object by using a hook assembly 177 inserted into a holder part 167 or being configured to rotate the clamped work object by rotating the holder part 167 by using an electric handle 155 connected to the holder part 167 through an insulating rod part 110, the clamp stick including: an operation rod 125 mounted such that the operation rod 125 passes through a hollow of the insulating rod part 110, the operation rod 125 being mounted such that a front side of the operation rod 125 is connected to a rear side of the hook assembly 177; and the double pawl operation unit 135 mounted on a rear side of the insulating rod part 110, the double pawl operation unit 135 being mounted such that the double pawl operation unit 135 is connected to a rear side of the operation rod 125, and the double pawl operation unit 135 being configured to adjust a depth at which the hook assembly 177 is inserted into the holder part 167, wherein the double pawl operation unit 135 is configured such that a two-stage movement operation in a front direction is capable of being performed after the double pawl operation unit 135 is moved in a rear direction with respect to the clamp stick, and the hook assembly 177 is configured such that the depth at which the hook assembly 177 is inserted into the holder part 167 is adjusted according to the two-stage movement operation of the double pawl operation unit 135.

### Advantageous Effects

In the electrically insulating rotary grip-all clamp stick (hereinafter, referred to as a ‘clamp stick’) having the double pawl operation unit for indirect hot-line work and the method for operating the indirect hot-line tool mechanism using the clamp stick according to the present disclosure as described above, since the clamp stick is configured such that a work object is capable of being easily caught on the hook of the holder part and the work object is solidly clamped by the clamp stick as a worker holds the clamp stick and operates the double pawl operation unit, there is an effect that the worker is capable of safely performing work. Furthermore, since the double pawl operation unit is constituted by using the rack and the pinion gear, the length of the double pawl operation unit is minimized, so that there is an effect that the worker is capable of conveniently and safely performing coupling and operating the tip tool by using the double pawl operation unit.

### DESCRIPTION OF DRAWINGS

FIG. 1 is a perspective view illustrating a clamp stick according to an exemplary embodiment of the present disclosure.

FIG. 2 to FIG. 4 are partial projection views illustrating a holder part and an insulating rod part of the clamp stick according to an exemplary embodiment of the present disclosure.

FIG. 5 is an exploded perspective view illustrating the holder part and the insulating rod part of the clamp stick according to an exemplary embodiment of the present disclosure.

FIG. 6 is an exploded perspective view illustrating the holder part of the clamp stick according to an exemplary embodiment of the present disclosure.

FIG. 7 is an exploded perspective view illustrating a hook assembly of the clamp stick according to an exemplary embodiment of the present disclosure.

FIG. 8 is a partial perspective view illustrating a double pawl operation unit of the clamp stick according to an exemplary embodiment of the present disclosure.

FIG. 9 and FIG. 10 are partial exploded perspective views illustrating the double pawl operation unit of the clamp stick according to an exemplary embodiment of the present disclosure.

FIG. 11 is a partial projection view illustrating the double pawl operation unit of the clamp stick according to an exemplary embodiment of the present disclosure.

FIG. 12 to FIG. 14 are partial projection views illustrating an operation of the double pawl operation unit of the clamp stick according to an exemplary embodiment of the present disclosure.

FIG. 15 shows a side surface projection view (a) and a rear surface projection view (b) that are illustrating a power transmission part of the clamp stick according to an exemplary embodiment of the present disclosure.

FIG. 16 shows a side surface projection view (a) and a rear surface projection view (b) that are illustrating a rotation prevention member of the clamp stick according to an exemplary embodiment of the present disclosure.

### DESCRIPTION OF REFERENCE NUMERALS OF MAIN PARTS OF DRAWINGS

110: insulating rod part 111: support pipe body
115: handle part 120: stick holder
121: upper holder 122: lower holder
125: operation rod 126: main rod
127: rear end rod 128: tip rod
129: coupling member 130: rotating pipe
131: rotating pipe main body 132: rotating pipe sub-body
134: rotating pipe coupling part 135: double pawl operation unit
135a: extension rod part 135b: ratchet plate
135b-1: ratchet gear 135b-2: locking ratchet
136: operation knob 136a: first pawl
136b: second pawl 137: lower rack gear
138: pinion part 138a: pinion gear
138b: body 138c: pinion support body
138c-1: guide protrusion 138d: bearing part
139: upper rack gear 139a: guide groove
155: electric handle 156: power transmission part
156a: gear housing 156b: first bevel gear
156c: second bevel gear 156c-1: coupling hole
157: handle body 158: rotation prevention member
158a: lower support body 158b: upper support body
158b-1: rotation prevention protrusion 167: holder part
168: rotating holder 169: holder body
170: holder guide groove 171: center guide groove
172: extension guide groove 174: holder coupling part
175: holder coupling hole 177: hook assembly
178: slider 179: slider body
180: slider coupling hole 181: slider middle groove
182: slider side portion groove 183: slider center groove
184: slider pin hole 186: slider wing
188: hook 189: hook pin hole
190: hook protrusion 191: pivot pin
192: spring 193, 194, 195, 196: bearings

### MODE FOR INVENTION

The present disclosure relates to an electrically insulating rotary grip-all clamp stick having a double pawl operation unit for indirect hot-line work and being used in hot-line work, and to a method for operating an indirect hot-line tool mechanism using the same. More particularly, the present disclosure relates to an electrically insulating rotary grip-all clamp stick having a double pawl operation unit for indirect hot-line work and being used in hot-line work, and to a method for operating an indirect hot-line tool mechanism using the same, the electrically insulating rotary grip-all clamp stick being configured such that the double pawl operation unit 135 is constituted by using a rack and a pinion gear so that a worker is capable of safely and more conveniently performing hot-line work or uninterruptible power work while supplying of electricity is not stopped. Furthermore, a holder part 167 and a hook assembly 177 inserted into the holder part 167 are operated by the double pawl operation unit 135 as described above, so that a tip tool or a work object (hereinafter, the term ‘tip tool’ and the term ‘work object’ may be used interchangeably.) is capable of being solidly coupled to a tip of the holder part 167. Particularly, since a length of the double pawl operation unit 135 is minimized, the worker is capable of easily holding and operating the tip tool when the worker operates the tip tool, performs work for removing a bind wire of a rotary wound-drawn type ultra-high-voltage distribution line, or performs work for foreign substances including a layer coating an electric wire.

In order to realize the electrically insulating rotary grip-all clamp stick having the double pawl operation unit for indirect hot-line work according to the present disclosure as described above, the electrically insulating rotary grip-all clamp stick having the double pawl operation unit for indirect hot-line work and being configured to clamp the work object by using the hook assembly 177 inserted into the holder part 167 or being configured to rotate the clamped work object by rotating the holder part 167 by using an electric handle 155 connected to the holder part 167 through an insulating rod part 110 includes: an operation rod 125 mounted in the in the insulating rod part 110 by passing through a hollow of the insulating rod part 110, the operation rod 125 being mounted such that a front side of the operation rod 125 is connected to a rear side of the hook assembly 177; and the double pawl operation unit 135 mounted on a rear side of the insulating rod part 110, the double pawl operation unit 135 being mounted such that the double pawl operation unit 135 is connected to a rear side of the operation rod 125, and the double pawl operation unit 135 being configured to adjust a depth at which the hook assembly 177 is inserted into the holder part 167.

In addition, the double pawl operation unit 135 of the present disclosure includes: an extension rod part 135a having a hollow and mounted on the rear side of the insulating rod part 110; an operation knob 136 having a hollow and mounted on an outer circumference of the extension rod part 135a such that the operation knob 136 is capable of being moved in front and rear directions; a lower rack gear 137 having a length in the front and rear directions and mounted in the hollow of the extension rod part 135a, the lower rack gear 137 being mounted such that the lower rack gear 137 is connected to the rear side of the operation rod 125; a pinion part 138 mounted on a rear side of the extension rod part 135a, the pinion part 138 being mounted in the hollow of the operation knob 136, having a hollow such that a rear side of the rack gear 137 passes therethrough, and having a pinion gear 138a which corresponds to the lower rack gear 137 and which is provided on an upper portion of the lower rack gear 137; and an upper rack gear 139 having a length in the front and rear directions, the upper rack gear 139 being fixedly mounted in the hollow of the operation knob 136, being fixedly mounted such that the upper rack gear 139 is positioned on an upper portion of the pinion gear 138a, corresponding to the pinion gear 138a, and being configured to be moved in a direction same as a moving direction of the lower rack gear 137.

In addition, the double pawl operation unit 135 of the present disclosure includes a ratchet plate 135b fixedly mounted on the outer circumference of the extension rod part 135a, the ratchet plate 135b being fixedly mounted such that the ratchet plate 135b is positioned on a lower portion of the upper rack gear 139, and the ratchet plate 135b having a pair of ratchet gears 135b-1 formed on an upper surface of the ratchet plate 135b along the front and rear directions such that the ratchet gears 135b-1 are positioned on opposite sides of the upper rack gear 139. Furthermore, the operation knob 136 includes a first pawl 136a mounted such that the first pawl 136a passes through a front upper side of the operation knob 136, the first pawl 136a being mounted such that the first pawl 136a corresponds to the ratchet gears 135b-1.

In addition, the pinion part 138 of the present disclosure includes: a body 138b coupled to the rear side of the extension rod part 135a, the body 138b having an upper outer circumference that is open, and the body 138b having a hollow such that the rear side of the lower rack gear 137 passes therethrough; and a pair of pinion support bodies 138c formed on opposite sides of the open upper portion of the body 138b, the pinion support bodies 138c being provided such that the pinion gear 138a is capable of being rotated.

In addition, the upper rack gear 139 of the present disclosure includes a guide groove 139a formed in a longitudinal direction on each both side surface of the upper rack gear 139, and the pinion support bodies 138c of the pinion part 138 include respective guide protrusions 138c-1 which protrude on upper portions of inner side surfaces of the pinion support bodies 138c and which are inserted into the guide grooves 139a.

In addition, the pinion part 138 of the present disclosure includes a bearing part 138d which is mounted on a lower portion of the hollow of the body 138b and which supports a lower surface of the lower rack gear 137.

In addition, the ratchet plate 135b of the present disclosure includes a locking ratchet 135b-2 formed on a front side of the upper surface of the ratchet plate 135b, the locking ratchet 135b-2 being positioned between the pair of ratchet gears 135b-1. Furthermore, the operation knob 136 includes a second pawl 136b mounted such that the second pawl 136b passes through the front upper side of the operation knob 136, the second pawl 136b being mounted such that the second pawl 136b passes through a center of the first pawl 136a, and the second pawl 136b corresponding to the locking ratchet 135b-2.

In addition, the insulating rod part 110 of the present disclosure includes: a rotating pipe 130 having a hollow and mounted on an outer circumference of the operation rod 125, the rotating pipe 130 being mounted such that a front side of the rotating pipe 130 is connected to a rear side of the holder part 167; and a support pipe body 111 having a hollow and mounted on an outer circumference of the rotating pipe 130, the support pipe body 111 being mounted such that the holder part 167 is connected to a front side of the support pipe body 111 so that the holder part 167 is capable of being rotated. Furthermore, the electric handle 155 includes: a power transmission part 156 mounted between a rear side of the support pipe body 111 and a front side of the double pawl operation unit 135, the power transmission part 156 being mounted such that a power is capable of being transmitted to the rotating pipe 130, and the power transmission part 156 being configured such that the rear side of the operation rod 125 passes through the power transmission part 156; a handle body 157 mounted on an upper portion of the power transmission part 156 and provided with a driving motor; and a rotation prevention member 158 mounted inside the power transmission part 156, the rotation prevention member 158 being configured to prevent a rotation of the rotating pipe 130 when the handle body 157 is separated from the power transmission part 156.

In addition, the power transmission part 156 of the present disclosure includes: a gear housing 156a mounted between a rear side of the support pipe body 111 and the front side of the double pawl operation unit 135; a first bevel gear 156b mounted on a front inner side of the gear housing 156a and connected to a rear side of the rotating pipe 130; and a second bevel gear 156c mounted on an upper inner side of the gear housing 156a, the second bevel gear 156c corresponding to the first bevel gear 156b and having a coupling hole 156c-1 that penetrates the second bevel gear 156c. Furthermore, the rotation prevention member 158 includes: a lower support body 158a mounted on a lower inner side of the gear housing 156a; and an upper support body 158b mounted on an upper portion of the lower support body 158a such that the upper support body 158b is elastically supported in an upward direction, the upper support body 158b being provided with a rotation prevention protrusion 158b-1 which is inserted into the coupling hole 156c-1 of the second bevel gear 156c and which is configured to prevent a rotation of the second bevel gear 156c.

In order to realize the method for operating the indirect hot-line tool mechanism using the electrically insulating rotary grip-all clamp stick having the double pawl operation unit for indirect hot-line work according to the present disclosure as described above, the method includes: a first preparation process S10 in which the electrically insulating rotary grip-all clamp stick for indirect hot-line work as described above is prepared; a second preparation process S20 in which a tip tool is coupled to the hook assembly 177; and a work performing process in which the electric handle 155 is operated so that the holder part 167 is rotated and the tip tool is rotated, thereby winding an electric wire on the tip tool or removing foreign substances such as dust and a layer coated on the electric wire.

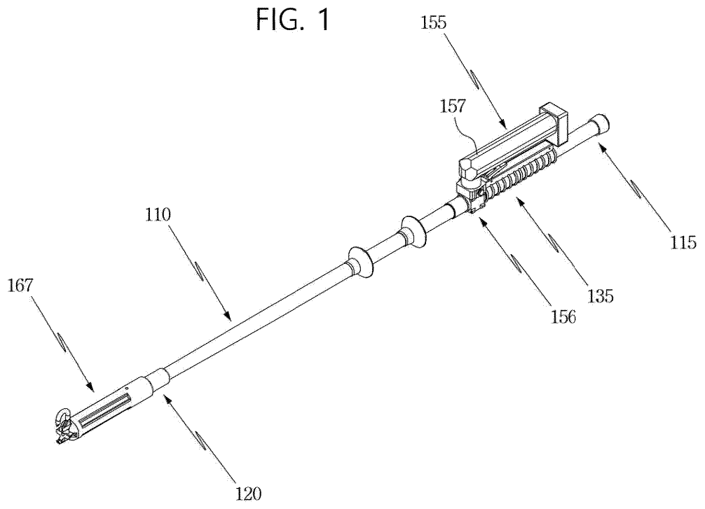

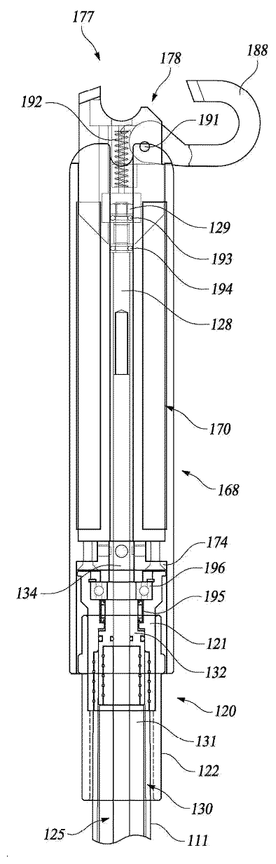

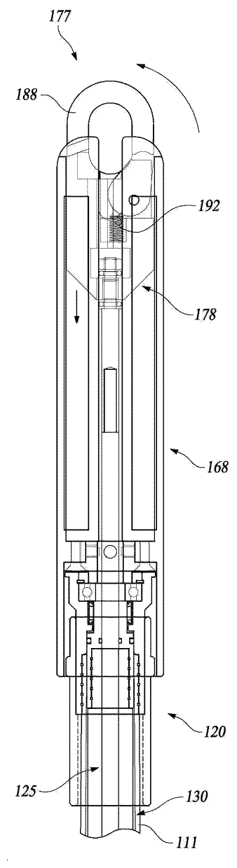

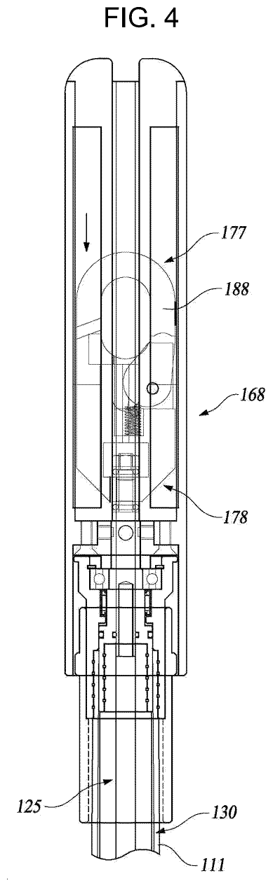

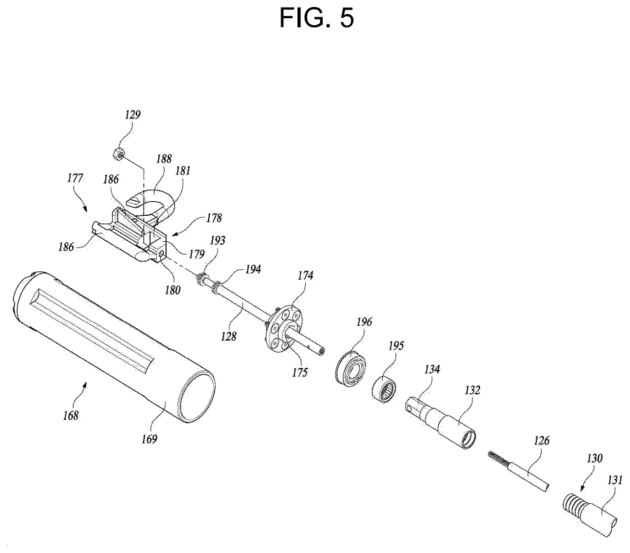

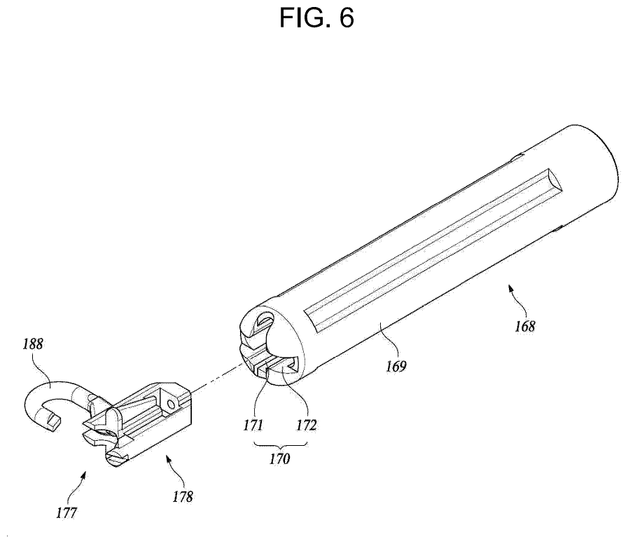

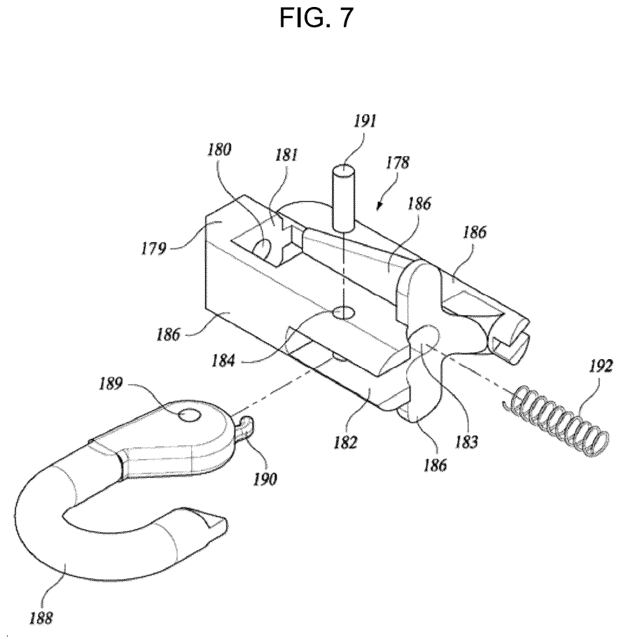

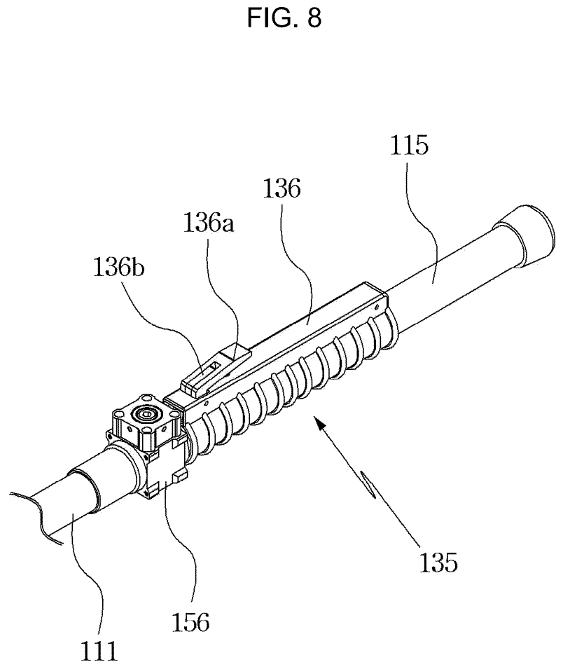

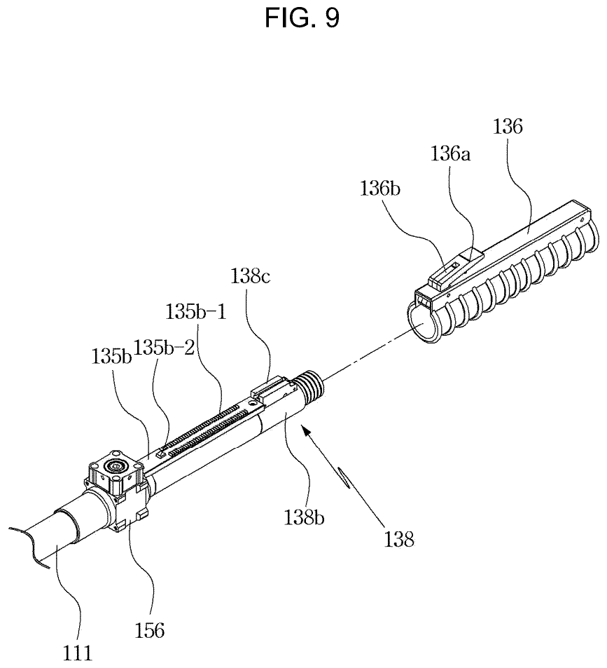

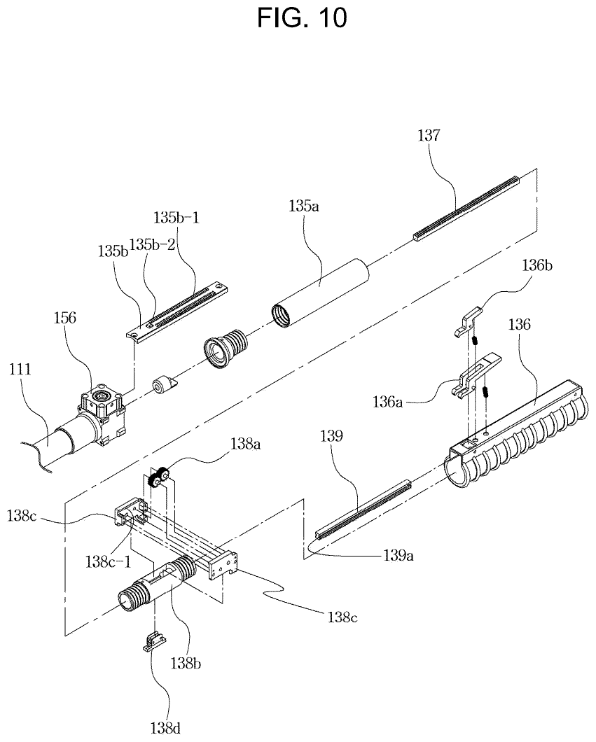

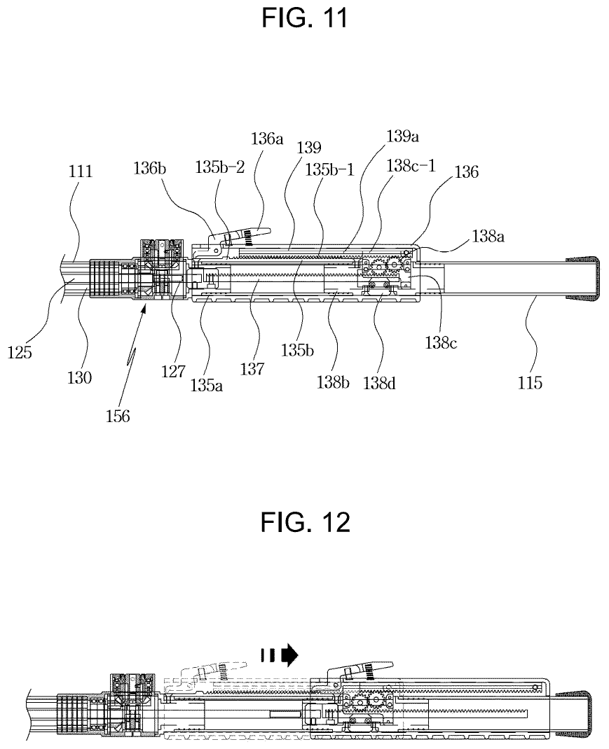

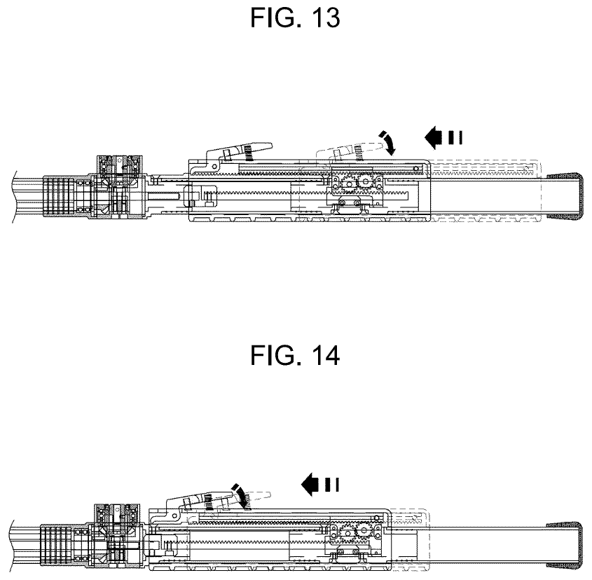

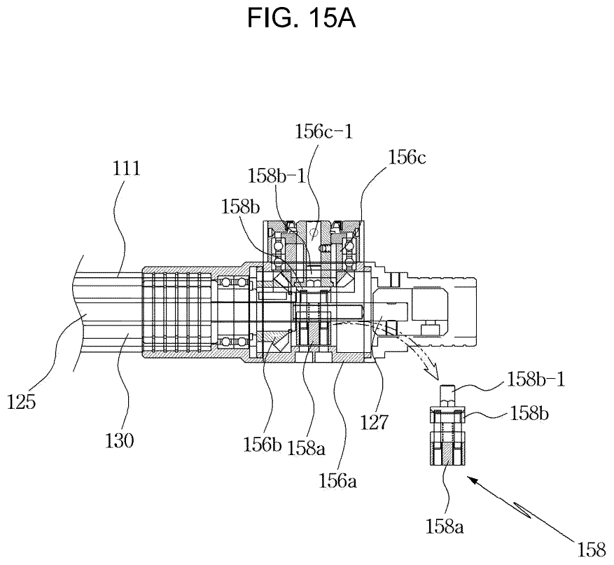

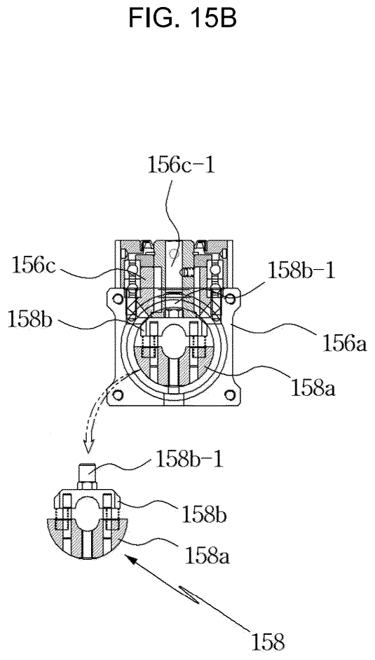

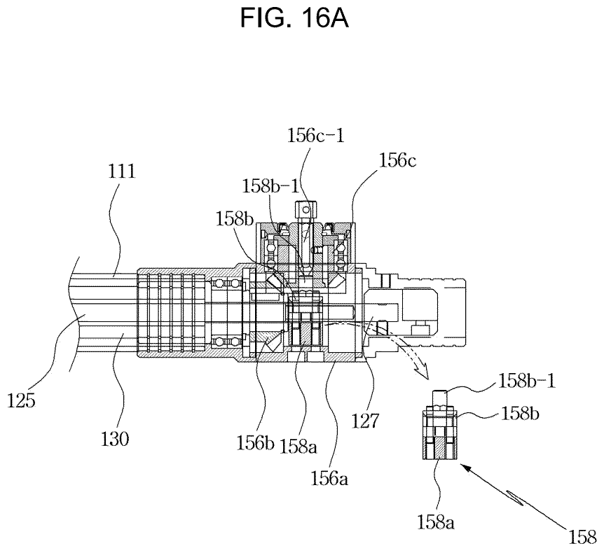

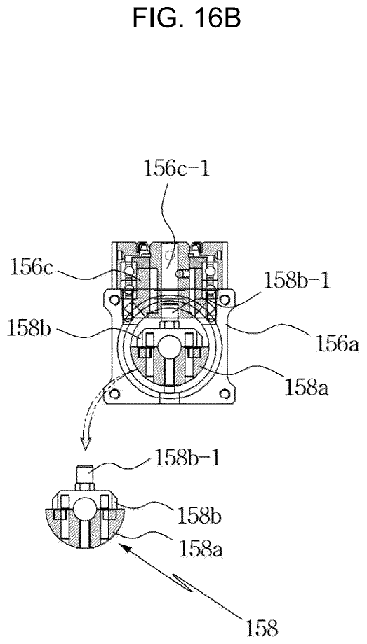

Hereinafter, an embodiment of the present disclosure will be described in detail with reference to FIG. 1 to FIG. 16.

First, the electrically insulating rotary grip-all clamp stick (hereinafter, referred to as the ‘clamp stick’) having the double pawl operation unit for indirect hot-line work according to the present disclosure includes the holder part 167 provided on a tip of the clamp stick, the hook assembly 177 inserted into the holder part 167, the insulating rod part 110 connected to the rear side of the holder part 167, the power transmission part 156 mounted on the rear side of the insulating rod part 110, the electric handle 155 connected to the upper portion of the power transmission part 156, and the handle part 115 connected to the rear side of the power transmission part 156.

The clamp stick of the present disclosure is configured to clamp a work object by using the hook assembly 177 inserted into the holder part 167, or to rotate the clamped work object by rotating the electric handle 155 connected to the holder part 167 through the insulating rod part 110, thereby allowing indirect hot-line work to be performed. More specifically, the clamped work object is rotated by rotating the holder part 167 by using the electric handle 155 that is connected to the holder part 167 through the insulating rod part 110 and the power transmission part 156.

At this time, in the clamp stick of the present disclosure, since the double pawl operation unit 135 is mounted on the handle part 115, the hook assembly 177 is capable of being operated such that the hook assembly 177 is capable of being inserted into or pulled out from the holder part 167. Therefore, a work object or a tip tool is capable of being solidly coupled to the hook assembly 177, so that the worker is capable of easily holding and operating the tip tool when the worker operates the tip tool, performs work for removing a bind wire of a rotary wound-drawn type ultra-high-voltage distribution line, or performs work for removing foreign substances including a layer coating an electric wire.

Hereinafter, in the description of configurations of the double pawl operation unit 135 having characteristics of the present disclosure, although the configuration of the power transmission part 156 will be described later, it will be clear that the configurations of the double pawl operation unit 135 are capable of being organically connected and operated even without the configuration of the power transmission part 156. However, the power transmission part 156 is an essential configuration when the holder part 167 is rotated through the electric handle 155. Therefore, it is clear that a precondition that the power transmission part 156 is mounted between the insulating rod part 110 and the double pawl operation unit 135 exists even when the configuration of the power transmission part 156 is not mentioned.

In addition, it will be clear that the tip and the rear end mentioned in the present disclosure are used with the same and similar meaning as the front side and the rear side, respectively, with only a different term.

The clamp stick of the present disclosure includes the insulating rod part 110 that a user can hold and operate with the user's hand, the operation rod 125 and the rotating pipe 130 that are disposed inside the insulating rod part 110, the electric handle 155 disposed on a rear end of the insulating rod part 110 and connected to the operation rod 125, and the holder part 167 disposed on a tip of the insulating rod part 110.

At this time, the insulating rod part 110, the operation rod 125, and the rotating pipe 130 are configured as insulators that are not electrically conductive, and the clamp stick of the present disclosure is capable of being conveniently and safely used in performing a variety of indirect hot-line work since the holder part 167 is used such that the holder part 167 holds work objects such as indirect hot-line tools mounted on an electric pole and so on and thus the user does not be required to hold work objects with the user's hand.

Specifically, the insulating rod part 110 includes the support pipe body 111 having the hollow, the operation rod 125 disposed inside the support pipe body 111, and the rotating pipe 130 disposed inside the support pipe body 111 and disposed outside the operation rod 125. Furthermore, the power transmission part 156, which will be described in detail later, is connected to a rear end of the support pipe body 111, and the handle part 115, which will be described in detail later, is connected to a rear end of the power transmission part 156.

In other words, the insulating rod part 110 includes the operation rod 125 that is mounted such that the operation rod 125 passes through the hollow of the insulating rod part 110, the operation rod 125 being mounted such that the front side of the operation rod 125 is connected to the rear side of the hook assembly 177 that will be described later in detail. Furthermore, the insulating rod part 110 includes the rotating pipe 130 having the hollow therein and mounted on the outer circumference of the operation rod 125, the rotating pipe 130 being mounted such that the front side of the rotating pipe 130 is connected to the rear side of the holder part 167. Furthermore, the insulating rod part 110 includes the support pipe body 111 having the hollow therein and mounted on the outer circumference of the rotating pipe 130, the support pipe body 111 being mounted such that the holder part 167 is connected to the front side of the support pipe body 111 so that the holder part 167 is capable of being rotated.

The support pipe body 111 is formed in a hollow pipe shape such that a space capable of accommodating the operation rod 125, the rotating pipe 130, and so on is provided inside the support pipe body 111, and a stick holder 120 configured to support the holder part 167 such that the holder part 167 is capable of being rotated is provided on a tip of the support pipe body 111. Furthermore, the stick holder 120 includes an upper holder 121 to which the holder part 167 is coupled such that the holder part 167 is capable of being rotated, and includes a lower holder 122 fixing the upper holder 121 to the support pipe body 111 while the lower holder 122 surrounds the support pipe body 111 and the upper holder 121. Furthermore, the upper holder 121 and the lower holder 122 have hollow structures in which the rotating pipe 131 is capable of passing therethrough.

In addition, a protective skirt (not illustrated) is coupled to a middle portion of the support pipe body 111, and the protective skirt is disposed such that the protective skirt protrudes from an outer surface of the support pipe body 111 along a circumference of the support pipe body 111. Furthermore, the protective skirt serves to prevent foreign substances falling from the work object and so on from reaching the worker when the holder part 167 holds the work object, and serves to prevent the worker's hand from excessively accessing the holder part 167 during hot-line work.

In addition, the power transmission part 156, which will be described in detail later, connects the support pipe body 111 and the handle part 115 to each other between the support pipe body 111 and the handle part 115, and an accommodating space capable of accommodating the first bevel gear 156b, the second bevel gear 156c, and the rotation prevention member 158 that will be described in detail is formed inside the power transmission part 156.

At this time, a connection boss (not illustrated) is coupled to an outside of the power transmission part 156. That is, the connection boss is coupled to an upper portion of the transmission part 156. Furthermore, the connection boss protrudes on the outside of the power transmission part 156. That is, the connection boss protrudes on the upper portion of the power transmission part 156. Furthermore, a fastening groove (not illustrated) for being fastened to the electric handle 155 is formed on the connection boss.

In addition, the handle part 115 extends from the rear end of the power transmission part 156 so that the worker can hold the handle part 115 with the worker's hand, and the double pawl operation unit 135, which will be described in detail later, is coupled to the handle part 115 such that the double pawl operation unit 135 is capable of being moved in the front and rear directions that are a longitudinal direction. In the drawings, it is illustrated that the handle part 115 is coupled to the rear side of the double pawl operation unit 135 that will be described in detail later, but the structure of the handle part 115 may be changed in various manners.

In relation with the description mentioned above, the operation rod 125 is disposed inside the rotating pipe 130 that is disposed in the hollow of the insulating rod part 110. Specifically, the operation rod 125 is disposed such that the operation rod 125 is capable of being rectilinearly moved in the hollow provided inside the rotating pipe 130. That is, the operation rod 125 is capable of being moved in the front and rear directions in the hollow provided inside the rotating pipe 130.

At this time, the operation rod 125 includes a main rod 126, a rear end rod 127 coupled to a rear end of the main rod 126, a connector (not illustrated) which is coupled to a rear end of the rear end rod 127 and to which a tip of the lower rack gear 137 that will be described in detail later is coupled, and a tip rod 128 coupled to a tip of the main rod 126.

The rear end rod 127 is coupled to the connector such that the rear end rod 127 is capable of being rotated, the tip rod 128 is coupled to the holder part 167 such that the tip rod 128 is capable of being rotated, and the rear end rod 127 and the tip rod 128 may be coupled to the main rod 126 in a screw-coupling manner. As such, when the operation rod 125 is configured as a prefabricated structure having three parts, there is an effect of easily assembling the operation rod 125 with the holder part 167 and with the double pawl operation unit 135.

In addition, a tip coupling member 129 for being coupled to the holder part 167 is coupled to the tip rod 128, and such an operation rod 128 may transmit a rectilinear movement force of the double pawl operation unit 135 according to the operation of the user to the holder part 167. Specifically, the rectilinear movement force may be transmitted to the hook assembly 177.

In relation with the description mentioned above, the rotating pipe 130 is disposed on the support pipe body 111 such that the rotating pipe 130 is capable of being rotated, and is coupled to the holder part 167.

Specifically, the rotating pipe 130 includes a rotating pipe main body 131 and a rotating pipe sub-body 132 that is coupled to a tip of the rotating pipe main body 131. Furthermore, the hollow for accommodating the operation rod 125 is formed inside the rotating pipe 130, and a rotating pipe coupling part 134 coupled to the holder part 167 is provided on a tip of the rotating pipe sub-body 132. Furthermore, the rotating pipe coupling part 134 is configured to transmit a rotational force of the electric handle 155 to the holder part 167.

In relation with the description mentioned above, the electric handle 155 includes the power transmission part 156 mounted between the support pipe body 111 and the double pawl operation unit 135 that will be described in detail later, the power transmission part 156 being mounted between the rear side of the support pipe body 111 and the front side of the double pawl operation unit 135 that will be described in detail later, the power transmission part 156 being mounted such that a power is capable of being transmitted between the rotating pipe 130 and the electric handle 155, and the power transmission part 156 being configured such that the power transmission part 156 passes through the rear side of the operation rod 125. Furthermore, the electric handle 155 includes the handle body 157 mounted on the upper portion of the power transmission part 156 and provided with the driving motor (not illustrated), and includes the rotation prevention member 158 mounted inside the power transmission part 156, the rotation prevention member 158 being configured to prevent a rotation of the rotating pipe 130 when the handle body 157 is separated from the power transmission part 156.

The electric handle 155 is connected to the rotating pipe 130 through the power transmission part 156 such that a power is capable of being transmitted between the electric handle 155 and the rotating pipe 130. Therefore, when the electric handle 155 is operated by the worker, the electric handle 155 transmits a driving force from the driving motor to the rotating pipe 130 through the power transmission part 156, and the rotating pipe 130 is rotated, so that the holder part 167 coupled to the tip of the rotating pipe 130 is rotated.

Specifically, the power transmission part 156 includes the gear housing 156a mounted between the support pipe body 111 and the double pawl operation unit 135, the gear housing 156a being mounted between the rear side of the support pipe body 111 and the front side of the double pawl operation unit 135. Furthermore, the power transmission part 156 includes the first bevel gear 156b mounted on the front inner side of the gear housing 156a and connected to the rear side of the rotating pipe 130, and includes the second bevel gear 156c mounted on the upper inner side of the gear housing 156a, the second bevel gear 156c corresponding to and being engaged with the first bevel gear 156b, and the second bevel gear 156c having the coupling hole 156c-1 which penetrates the second bevel gear 156c and to which a handle shaft (not illustrated) of the electric handle 155 is detachably coupled.

Although the coupling hole 156c-1 is simply illustrated as a circular hole in the drawings, a cross-sectional shape of the coupling hole 156c-1 is non-circular, and the cross-sectional shape of the coupling hole 156c-1 is formed in a polygonal shape corresponding to a shape of the handle shaft of the electric handle 155. Furthermore, the second bevel gear 156c is exposed to the outside of the gear housing 156a. That is, the second bevel gear 156c is exposed to the upper portion of the gear housing 156a.

Accordingly, when the driving motor of the electric handle 155 is operated, the second bevel gear 156c is rotated, and the first bevel gear 156b is rotated in conjunction with the second bevel gear 156c, so that the rotating pipe 130 is rotated, thereby rotating the holder part 167.

At this time, the first bevel gear 156b and the second bevel gear 156c may be supported by a bearing (not illustrated) disposed in the gear housing 156a such that the first bevel gear 156b and the second bevel gear 156c are capable of being rotated. Furthermore, the worker may separate the handle shaft of the electric handle 155 from the coupling hole 156c-1 as required, and may couple a manual wrench to the coupling hole 156c-1 in which the handle shaft is separated and then may manually rotate the second bevel gear 156c.

In addition, although it is illustrated in the drawings that the handle shaft is disposed approximately perpendicular to the rotating pipe 130 and the power transmission part 156 includes two bevel gears (the first bevel gear 156b and the second bevel gear 156c) arranged approximately perpendicular to each other, it will be clear that the structure of the power transmission part 156 may be variously changed. That is, the power transmission part 156 may have a structure including a gear train other than the bevel gears, or may have a structure including another power transmission member capable of transmitting a rotational force of the electric handle 155 to the rotating pipe 130 other than a gear. Furthermore, it is preferable that the power transmission part 156 has the structure including the bevel gears when the rotation prevention member 158 that will be described in detail later is included in the power transmission part 156.

In relation with the description mentioned above, the electric handle 155 is disposed on a side of the handle part 115 of the insulating rod part 110 such that the electric handle 155 is capable of providing a rotational force to the rotating pipe 130 through the power transmission part 156. Such an electric handle 155 includes the handle body 157 detachably coupled to the insulating rod part 110, the handle shaft connected to the power transmission part 156, the driving motor configured to generate a driving force for rotating the handle shaft, and a switch (not illustrated) for operation by a worker.

The handle shaft protrudes toward a first side of the handle body 157. That is, the handle shaft protrudes outward that is downward from a lower portion of the handle body 157. As described above, a cross-sectional shape of the handle shaft has a non-circular shape, and the handle shaft is detachably coupled to the coupling hole 156c-1 of the second bevel gear 156c. Furthermore, the driving motor may be realized in various structures such as a motor and so on capable of generating a rotational force, and is operated according to the operation of the switch.

In addition, the first side of the handle body, which is the lower portion of the handle body 157, is provided with a handle coupler (not illustrated) capable of being detachably coupled to the connection boss of the insulating rod part 110. Furthermore, the handle coupler includes a coupler body (not illustrated) capable of being coupled to the connection boss, and includes a clamp unit (not illustrated) coupled to the coupler body such that the coupler body is capable of being fixed to the connection boss.

A coupler groove (not illustrated) capable of accommodating the connection boss is provided inside the coupler body, the handle shaft protrudes outside the coupler body through the coupler groove, a coupler body groove (not illustrated) for mounting the clamp unit is provided on an outer surface of the coupler body, and the coupler groove and the coupler body groove are connected to each other through a coupler body through-hole (not illustrated).

The clamp unit includes a button (not illustrated) coupled to the coupler body groove, a stopper member (not illustrated) disposed inside the button, a stopper member spring (not illustrated) disposed between the button and the stopper member, and a plurality of pressing balls (not marked) capable of operating the stopper member in conjunction with a movement of the button.

The button is coupled to the coupler body groove such that the button is exposed to an outside of the coupler body for operation by a worker, a button groove (not illustrated) is formed inside the button, and the stopper member and the stopper member spring are disposed in the button groove.

A first end portion of the button is provided with a button inclined surface (not illustrated) with which the plurality of pressing balls is in contact, and the button inclined surface is provided such that the button inclined surface is inclined in a direction in which the plurality of pressing balls is capable of being pressed to a side of the stopper member.

The button may be elastically supported by an elastic force of the stopper member spring, and may protrude from the outer surface of the coupler body. Furthermore, when the worker presses the button, the button may be moved toward the coupler groove while compressing the stopper member spring.

The stopper member is covered by the button such that the stopper member is capable of being linearly moved inside the button, and a portion of the stopper member may enter the coupler groove through the coupler body through-hole of the coupler body. Furthermore, when the handle coupler is coupled to the connection boss of the insulating rod part 110, an end of the stopper member that enters inside the coupler groove may be inserted into the fastening groove of the connection boss.

A stopper member inclined surface (not illustrated) with which the plurality of pressing balls is in contact is provided on an outer surface of the stopper member, and the stopper member is moved in a direction away from the coupler groove when the plurality of pressing balls is pressed by the stopper member inclined surface.

The stopper member spring is disposed between the button and the stopper member, thereby applying an elastic force to the stopper member in a direction of entering inside the coupler groove. Therefore, when no other external force is applied, the stopper member may maintain a state in which the end of the stopper member enters inside the coupler groove by the elastic force of the stopper member spring.

At this time, the plurality of pressing balls is disposed around a circumference of the stopper member, and each pressing ball is capable of performing a rolling movement since each pressing ball is disposed such that a first side of the each pressing ball is in contact with the button inclined surface of the button and a second side of each pressing ball is disposed inside the coupler body groove so that the second side of each pressing ball is in contact with the stopper member inclined surface of the stopper member. When the button is pressed by the worker, the plurality of pressing balls is pressed by the button inclined surface and is moved toward the stopper member, so that the stopper member may be pressed in a direction of retracting the stopper member from the coupler groove.

Due to such an action of the handle coupler, the handle body 157 may be stably fixed to the insulating rod part 110, and the handle body 157 may be separated from the insulating rod part 110 as required. That is, when the coupler body is disposed such that the coupler body surrounds the connection boss, the end of the stopper member enters inside the coupler groove and is inserted into the fastening groove of the connection boss. At this time, as the stopper member spring presses the stopper member toward the coupler groove, the stopper member may maintain the state in which the stopper member is inserted into the fastening groove, and the handle coupler may stably maintain a state in which the handle coupler is coupled to the insulating rod part 110. In this state, since the handle shaft is coupled to the coupling hole 156c-1 of the second bevel gear 156c, the driving force of the driving motor may be transmitted to the second bevel gear 156c through the handle shaft when the worker operates the switch.

Meanwhile, when the worker presses the button, the plurality of pressing balls is moved toward the stopper member. At this time, the plurality of pressing balls presses the stopper member in the direction of retracting the stopper member from the coupler groove, and the stopper member is separated from the fastening groove of the connection boss while the stopper member compresses the stopper member spring and is moved. At this time, since the handle coupler is released from the insulating rod part 110, the electric handle 155 may be separated from the insulating rod part 110.

In the drawings, although it is illustrated that a plurality of fastening grooves is formed in the connection boss and a plurality of clamp units is provided on the handle coupler, the number of clamp units may be variously changed.

In addition, the structure of the handle coupler is not limited to the illustrated one, and the structure of the handle coupler may be changed to various other structures capable of being detachably coupled to the insulating rod part 110. Furthermore, since the structure is the same as the structure described in the Korean Patent No. 10-2235044 that is filed by the present applicant and registered, the reference numerals of the elements are omitted.

Meanwhile, the rotation prevention member 158 described above is mounted inside the power transmission part 156, and is configured to prevent a rotation of the rotating pipe 130 when the handle body 157 is separated from the power transmission part 156. That is, the rotation prevention member 158 is configured to prevent a rotation of the second bevel gear 156c when the electric handle 155 is separated from the insulating rod part 110.

Specifically, the rotation prevention member 158 includes the lower support body 158a mounted on the lower inner side of the gear housing 156a, and includes the upper support body 158b mounted on the upper portion of the lower support body 158a such that the upper support body 158b is elastically supported in the upward direction, the upper support body 158b being provided with the rotation prevention protrusion 158b-1 which is inserted into the coupling hole 156c-1 of the second bevel gear 156c and which is configured to prevent the rotation of the second bevel gear 156c.

At this time, the rotation prevention protrusion 158b-1 is formed in a shape that corresponds to the coupling hole 156c-1. That is, the rotation prevention protrusion 158b-1 is formed in a shape having a cross-sectional shape that has a non-circular shape, so that the rotation prevention protrusion 158b-1 is configured to prevent the rotation of the second bevel gear 156c when the rotation prevention protrusion 158b-1 is inserted into the coupling hole 156c-1.

In addition, a plurality of elastic springs (not illustrated) elastically supporting the upper support body 158b in the upward direction is included between the lower support body 158a and the upper support body 158b. Therefore, when the handle shaft of the electric handle 155 is inserted into the coupling hole 156c-1, the upper support body 158b is moved in a downward direction, and the rotation prevention protrusion 158b-1 is separated from the coupling hole 156c-1, so that the second bevel gear 156c is capable of being rotated. When the handle shaft of the electric handle 155 is separated from the coupling hole 156c-1, the rotation prevention protrusion 158b-1 is inserted into the coupling hole 156c-1, and the rotation of the second bevel gear 156c is automatically prevented, so that the rotating pipe 130 is prevented from being freely rotated.

That is, when the electric handle 155 is not required during work, the rotation prevention member 158 automatically prevents the rotation of the rotating pipe 130 without inserting a separate member preventing a rotation into the coupling hole 156c-1 while the electric handle 155 is separated, thereby realizing an effect of further improving efficiency of work.

In relation with the description mentioned above, the holder part 167 is mounted on the tip of the insulating rod part 110 so that the work object can be clamped. Specifically, the holder part 167 includes a rotating holder 168 supported on the stick holder 120, and includes the hook assembly 177 coupled to the rotating holder 168 such that the hook assembly 177 is capable of being moved.

The rotating holder 168 is coupled to the rotating pipe 130 such that the rotating holder 168 is capable of being rotated together with the rotating pipe 130, and is supported on the stick holder 120 such that the rotating holder 168 is capable of being rotated. Specifically, the rotating holder 168 includes a holder body 169 supporting the hook assembly 177, and includes a holder coupling part 174 disposed on a rear end of the holder body 169 and coupled to the rotating pipe 130.

A holder guide groove 170 in which the hook assembly 177 is coupled such that the hook assembly 177 is capable of being moved is provided inside the holder body 169. Specifically, the holder guide groove 170 includes a center guide groove 171 disposed in a center of the holder body 169, and includes a plurality of extension guide grooves 172 that radially extends on the holder body 169 from the center guide groove 171. A penetration hole 173 in communication with the holder guide groove 170 such that the operation rod 125 passes therethrough is provided in a rear end of the holder body 169.

The holder coupling part 174 is coupled to the rear end of the holder body 169, and connects the holder body 169 and the rotating pipe 130 to each other. The holder coupling part 174 is provided with a holder coupling hole 175 that is in communication with the penetration hole 173 of the holder body 169. The rotating pipe coupling part 134 of the rotating pipe 130 is inserted into the holder coupling hole 175. The holder coupling hole 175 is formed in a shape corresponding to a shape of the rotating pipe coupling part 134 having a non-circular cross-sectional shape. As the rotating pipe coupling part 134 is inserted into the holder coupling hole 175, the rotating pipe 130 may be coupled such that the rotating pipe 130 cannot rotate relative to the rotating holder 168, and the rotational force of the rotating pipe 130 may be transmitted to the rotating holder 168.

In the drawings, it is illustrated that the rotating pipe coupling part 134 having a polygonal column shape that has a non-circular cross-sectional shape is inserted into the holder coupling hole 175 of the rotating holder 168 so that the rotating pipe 130 and the rotating holder 168 are coupled to each other, but the shape of the rotating pipe coupling part 134 and the shape of the holder coupling hole 175 are not limited to the illustrated shapes. In addition, a coupling structure between the rotating pipe 130 and the rotating holder 168 may be variously changed.

In addition to the structure in which the rotating holder 168 includes the holder body 169 having a substantially cylindrical shape and includes the holder coupling part 174 coupled to the rear end of the holder body 169 as illustrated in the drawings, the rotating holder 168 may be changed to various different structures in which the rotating holder 168 is capable of being coupled to the rotating pipe 130 while the rotating holder 168 supports the hook assembly 177 such that the hook assembly 177 is capable of being moved.

The hook assembly 177 includes a slider 178 disposed in the holder guide groove 170 of the rotating holder 168 such that the slider 178 is capable of being slidably moved, and includes a hook 188 coupled to the slider 178 such that a work object or various work tools (tip tools) are capable of being clamped.

The slider 178 includes a slider body 179 inserted into the center guide groove 171 of the holder guide groove 170, and includes a plurality of slider wings 186 that extends outward from the slider body 179 so that the plurality of slider wings 186 is capable of being inserted into the plurality of extension guide grooves 172. As the slider body 179 is inserted into the center guide groove 171 and the plurality of slider wings 186 is inserted into the plurality of extension guide grooves 172, the slider body 179 may be coupled to the rotating holder 168 such that the slider body 179 may be moved relative to the rotating holder 168 but may not be rotated relative to the rotating holder 168.

The slider body 179 includes a slider coupling hole 180, a slider middle groove 181, a slider side portion groove 182, a slider center groove 183, and a slider pin hole 184. The slider coupling hole 180 is disposed in a rear end of the slider body 179 such that the operation rod 125 is capable of being inserted into the slider coupling hole 180. The slider middle groove 181 is provided in the middle of the slider body 179 such that the slider middle groove 181 is connected to the slider coupling hole 180. At least a first side of the slider middle groove 181 is exposed to the outside, and an end of the tip rod 128 and the tip coupling member 129 are disposed in the slider middle groove 181. The slider side portion groove 182 is provided on a side portion of the slider body 179 such that an end of the hook 188 is inserted into the slider side portion groove 182. The slider center groove 183 is disposed in the center of the slider body 179 parallel to a movement direction of the slider body 179, and is exposed to the outside from a tip of the slider body 179. The slider pin hole 184 is formed in a direction orthogonal to the slider center groove 183 on the side portion of the slider body 179, and is connected to the slider side portion groove 182.

The hook 188 is formed in a curved shape such that the hook 188 is capable of clamping a work object, and is disposed in the slider 178 such that the hook is capable of being rotated. An end of a first side of the hook 188 is provided with a hook protrusion 190 and a hook pin hole 189 that corresponds to the slider pin hole 184 of the slider 178. The hook 188 is coupled to the slider 178 by a pivot pin 191 that is coupled to the slider 178, thereby being coupled to the slider 178 such that the hook 188 is capable of being rotated. That is, since the pivot pin 191 that is coupled to the slider pin hole 184 of the slider 178 is inserted into the hook pin hole 189 of the hook 188, the hook 188 is capable of being rotated with respect to the pivot pin 191 as a central axis of rotation. The hook protrusion 190 is disposed in the slider center groove 183 of the slider 178.

When the slider 178 is moved toward the stick 110, the hook 188 is rotated in contact with the rotating holder 168, so that the hook 188 is capable of clamping the work object. When the hook 188 is rotated in contact with the rotating holder 168, the hook 188 receives an elastic force of a spring 192. The spring 192 is disposed in the slider center groove 183 of the slider 178 such that the spring 192 is in contact with the hook protrusion 190 of the hook 188. The spring 192 may be compressed when the hook 188 is rotated in contact with the rotating holder 168, and may return the hook 188 to an original state by applying the elastic force to the hook 188 when the hook 188 is moved away from the holder guide groove 170.

The hook assembly 177 is coupled to the tip rod 128 of the operation rod 125 such that the hook assembly 177 is capable of being moved by the operation rod 125. Specifically, when the end of the tip rod 128 reaches the slider middle groove 181 through the slider coupling hole 180, the tip coupling member 129 is coupled to the end of the tip rod 128 in the slider middle groove 181, and the tip rod 128 and the hook assembly 177 may be coupled to each other. The tip rod 128 and the hook assembly 177 may be rotated relative to each other. In order for the tip rod 128 and the hook assembly 177 to be smoothly rotated relative to each other, a bearing 193 coupled to the tip coupling member 129 is disposed on the slider middle groove 181 such that the bearing 193 is interposed between an inner surface of the slider 178 and the tip coupling member 129. Another bearing 194 is coupled to the tip coupling member 129, and the bearing 194 is in contact with an outer surface of the slider 178, thereby allowing the tip rod 128 and the hook assembly 177 to be smoothly rotated relative to each other.

In addition, in an embodiment of the electrically insulating rotary grip-all clamp stick 100 for indirect hot-line work according to the present disclosure, the electrically insulating rotary grip-all clamp stick 100 includes bearings 195 and 196 disposed inside the stick holder 120. In order for the rotating pipe sub-body 132 of the rotating pipe 130 to be smoothly rotated relative to the stick holder 120, the bearings 195 and 196 support the rotating pipe sub-body 132 such that the rotating pipe sub-body 132 is capable of being rotated.

In relation with the description mentioned above, the double pawl operation unit 135 is mounted on the rear side of the insulating rod part 110. That is, the double pawl operation unit 135 is mounted on the rear side of the support pipe body 111. Furthermore, the double pawl operation unit 135 is coupled to the rear side of the operation rod 125, and is mounted such that the operation rod 125 is capable of being moved in the front and rear directions. Furthermore, the double pawl operation unit 135 is configured to adjust the depth at which the hook assembly 177 is inserted into the holder part 167.

Specifically, the double pawl operation unit 135 includes: the extension rod part 135a having the hollow and mounted on the rear side of the insulating rod part 110, the extension rod part 135a being mounted on the rear side of the insulating rod part 110 such that the extension rod part 135a is connected to the rear side of the support pipe body 111; the operation knob 136 having the hollow and mounted on the outer circumference of the extension rod part 135a such that the operation knob 136 is capable of being moved in the front and rear directions; the lower rack gear 137 having the length in the front and rear directions, the lower rack gear 137 having the length in a longitudinal direction of the extension rod part 135a, being mounted in the hollow of the extension rod part 135a, being mounted in the hollow such that the lower rack gear is connected to the rear side of the operation rod 125, and having a tooth formed on the upper surface of the lower rack gear 137; the pinion part 138 mounted on the rear side of the extension rod part 135a, the pinion part 138 being mounted in the hollow of the operation knob 136, having the hollow such that the rear side of the rack gear 137 passes therethrough, and having the pinion gear 138a which corresponds to the lower rack gear 137 and has a lower portion engaged with the lower rack gear 137 and which is provided on the upper portion of the lower rack gear 137; and the upper rack gear 139 having the length in the front and rear directions, the upper rack gear 139 having the length in the longitudinal direction of the extension rod part 135a, being fixedly mounted in the hollow of the operation knob 136, being fixedly mounted such that the upper rack gear 139 is positioned on the upper portion of the pinion gear 138a, corresponding to the pinion gear 138a such that a lower portion of the upper rack gear 139 is engaged with the upper portion of the pinion gear 138a, and being configured to be moved in the direction same as the moving direction of the lower rack gear 137.

In addition, when the power transmission part 156 is not mounted on the insulating rod part 110, which is when the power transmission part 156 is not mounted on the rear side of the support pipe body 111, the extension rod part 135a is mounted on the rear side of the support pipe body 111. Furthermore, when the power transmission part 156 is mounted on the rear side of the support pipe body 111, the extension rod part 135a is mounted on the rear side of the power transmission part 156.

At this time, the power transmission part 156 includes a penetration hole (not illustrated) formed through a rear surface of the power transmission part 156, the penetration hole being formed through the rear surface of the power transmission part 156 such that the connector and the rear side of the operation rod 125 that is the rear end rod 127 are passing through the penetration hole and are connected to each other. Furthermore, the power transmission part 156 includes a connection member (not illustrated) coupled to the rear side of the power transmission part 156 such that the extension rod part 135a is capable of being smoothly connected to the power transmission part 156. Furthermore, the connection member has a hollow such that the connector and the rear side of the operation rod 125 that is the rear end rod 127 are capable of passing through the hollow.

That is, the front side of the extension rod part 135a is coupled to a rear side of the connection member by a screw-coupling manner and so on, so that the extension rod part 135a is connected to the rear side of the connection member that is coupled to the rear side of the power transmission part 156. Furthermore, the lower rack gear 137 is mounted in the hollow of the extension rod part 135a, and is mounted such that the front side of the lower rack gear 137 is fixed to the rear side of the operation rod 125 that is the rear side of the connector.

The operation knob 136 has the hollow and is mounted on the outer circumference of the extension rod part 135a such that the operation knob 136 is capable of being moved in the front and rear directions, and is also mounted on the outer circumference of the handle part 115 such that the operation knob 136 is capable of being moved in the front and rear directions, the handle part 115 having the front side connected to the rear side of the pinion part 138. More specifically, the rear side of the operation knob 136 is supported by the pinion part 138, the front side of the operation knob 136 is supported by the first pawl 136a and the second pawl 136b that will be described in detail later, and the operation knob 136 is mounted on the outer circumference of the extension rod part 135a and the outer circumference of the handle part 115 such that the operation knob 136 is capable of being moved in the front and rear directions.

At this time, the upper rack gear 139 is mounted in the hollow of the operation knob 136, and has a gear protrusion part (not illustrated) that protrudes and extends on the upper portion of the operation knob 136 such that the pinion gear 138 and the ratchet plate 135b that will be described later in detail are mounted on the upper portion of the operation knob 136, the gear protrusion part having a mounting space (not illustrated) formed inside the gear protrusion part.

The front side of the lower rack gear 137 is fixedly coupled to the operation rod 125, and is mounted in the hollow of the extension rod part 135a. That is, the front side of the lower rack gear 137 is fixedly coupled to the rear side of the connector that is mounted on and connected to the rear side of the rear end rod 127. Furthermore, the lower rack gear 137 has the upper surface provided with a plurality of teeth corresponding to and being engaged with the pinion gear 138a of the pinion part 138.

The front side of the pinion part 138 is coupled to and connected to the rear side of the extension rod part 135a by a screw-coupling manner and so on, the rear side of the lower rack gear 137 passes through the hollow of the pinion part 138 such that the lower rack gear 137 is mounted in the hollow, the pinion gear 138a is mounted on the pinion part 138 such that the pinion gear 138a is capable of being rotated, the pinion part 138 is mounted on the lower rack gear 137 such that the pinion part 138 is positioned on the upper portion of the lower rack gear 137, and the pinion gear 138a is engaged with the lower rack gear 137.

Specifically, the pinion part 138 includes the body 138b having a front side coupled to the rear side of the extension rod part 135a by a screw-coupling manner and so on, the body 138b having the upper outer circumference that is open, and the body 138b having the hollow such that the rear side of the lower rack gear 137 passes therethrough. Furthermore, the pinion part 138 includes the pair of pinion support bodies 138c formed on the opposite sides of the open upper portion of the body 138b, the pinion support bodies 138c being provided such that the pinion gear 138a is capable of being rotated. At this time, the lower rack gear 137 is positioned between the pair of pinion support bodies 138c, and is configured to be smoothly moved in the front and rear directions. In addition, the front side of the handle part 115 is coupled to and connected to the rear side of the body 138b by a screw-coupling manner and so on.

In addition, the pinion part 138 includes the bearing part 138d which is mounted on the lower portion of the hollow of the body 138b and which supports the lower surface of the lower rack gear 137, the bearing part 138d being configured such that the lower rack gear 138 is capable of being smoothly moved in the front and rear directions. Specifically, the bearing part 138d includes a support part (not illustrated) fixedly mounted on opposite sides of the lower portion of the hollow of the body 138b, and includes at least one bearing (not illustrated) which is mounted on an upper inner side of the support part and which supports the lower surface of the lower rack gear 137. Therefore, the bearing part 138d is configured such that the lower rack gear 137 is capable of being smoothly moved when the lower rack gear 137 is moved in the front and rear directions.

In relation with the description mentioned above, the upper rack gear 139 has the length in the front and rear directions, and is fixedly mounted in the hollow of the operation knob 136 that is the gear protrusion part. Therefore, as the worker moves the operation knob 136 in the front and rear directions, the upper rack gear 139 is moved together with the operation knob 136. Furthermore, the upper rack gear 139 has the lower surface provided with a plurality of teeth such that the plurality of teeth corresponds to the pinion gear 138a and is engaged with the pinion gear 138a.

At this time, the upper rack gear 139 is moved in the same direction as the movement direction of the lower rack gear 137 by the pinion gear 138a. That is, as the pinion gear 138a is provided in an even number rather than an odd number, the lower rack gear 137 or the upper rack gear 139 is moved in the same direction that is the front direction or the rear direction when the upper rack gear 139 or the lower rack gear 137 is moved in the front direction or the rear direction.

In addition, the upper rack gear 139 includes the guide groove 139a formed in the longitudinal direction on each both side surface of the upper rack gear 139, and the pinion support body 138c of the pinion part 138 includes the guide protrusion 138c-1 which protrudes on the upper portion of the inner side surface of the pinion support body 138c and which is inserted into the guide groove 139a.

In a state in which the guide protrusion 138c-1 is fixed to the double pawl operation unit 135, the double pawl operation unit 135 is configured such that the upper rack gear 139 is more stably moved in the front and rear directions as the guide protrusion 138c-1 is stably moved in the front and rear directions by the guide groove 139a. Therefore, the pinion gear 138a is more stably rotated, so that the lower rack gear 137 is stably moved in the front and rear directions.

That is, when a worker intends to securely fix a work object by coupling the work object to the hook assembly 177, the lower rack gear 137 is moved in the front direction by the pinion gear 138a when the upper rack gear 139 is moved in the front direction by moving the operation knob 136 in the front direction, so that the hook assembly 177 protrudes toward the front side of the holder part 167. Furthermore, after the work object is coupled to the hook assembly 177, when the operation knob 136 is moved in the rear direction so that the upper rack gear 139 is moved in the rear direction, the lower rack gear 137 is moved in the rear direction by the pinion gear 138a, so that the work object is securely fixed to the hook assembly 177.

In addition, the double pawl operation unit 135 includes the ratchet plate 135b fixedly mounted on the outer circumference of the extension rod part 135a, the ratchet plate 135b being fixedly mounted such that the ratchet plate 135b is positioned on the lower portion of the upper rack gear 139, and the ratchet plate 135b having the pair of ratchet gears 135b-1 formed on the upper surface of the ratchet plate 135b along the front and rear directions such that the ratchet gears 135b-1 are positioned on the opposite sides of the upper rack gear 139. Furthermore, the operation knob 136 includes the first pawl 136a mounted such that the first pawl 136a passes through the front upper side of the operation knob 136, the first pawl 136a being mounted such that the first pawl 136a corresponds to the ratchet gears 135b-1.

In the drawings, it is illustrated that the front side of the ratchet plate 135b is not fixedly mounted on the outer circumference of the extension rod part 135a and the front side of the ratchet plate 135b is fixedly mounted on the outer circumference of the connection member coupled to the rear side of the power transmission part described above such that the ratchet plate 135b is in close contact with and is mounted on the outer circumference of the connection member and the outer circumference of the extension rod part 135a, but the ratchet plate 135b is capable of being fixedly mounted on the outer circumference of the extension rod part 135a.

In addition, the first pawl 136a is mounted on the front upper side of the operation knob 136 such that the first pawl 136a passes through the operation knob 136, is hinge-coupled to the operation knob 136 such that the first pawl 136a is capable of being rotated by a hinge shaft, and is mounted such that the rear side of the first pawl 136a is elastically supported in the upward direction. Furthermore, a lower end of the front side of the first pawl 136a corresponds to the pair of ratchet gears 135b-1 formed on the upper surface of the ratchet plate 135b, and is engaged with or released from the pair of ratchet gears 135b-1. At this time, the operation knob 136 includes a first spring (not illustrated) for supporting the rear side of the first pawl 136a in the upward direction. Furthermore, the first spring has a lower portion supported by the upper surface of the operation knob 136, and has an upper portion in close contact with the lower surface of the rear side of the first pawl 136a, thereby elastically supporting the rear side of the first pawl 136a in the upward direction.

That is, when the worker moves the operation knob 136 in the rear direction, the first pawl 136a allows the operation knob 136 to be smoothly moved in the rear direction. Furthermore, when the worker moves the operation knob 136 in the front direction, the lower end of the front side of the first pawl 136a is locked by the ratchet gear 135b-1, and the first pawl 136a restricts the operation knob from moving in the front direction, so that a state in which the work object is solidly coupled to the hook assembly 177 is maintained.

In addition, the ratchet plate 135b is formed in a shape in which the lower surface of the ratchet plate 135b is curved, and is formed in a shape corresponding to the outer circumference of the connection member and the outer circumference of the extension rod part 135a, so that a stably mounted state is maintained, thereby being capable of maintaining a state in which the first pawl 136a and the ratchet gear 135b-1 are solidly engaged with each other.

In addition, the ratchet plate 135b includes the locking ratchet 135b-2 formed on the front side of the upper surface of the ratchet plate 135b, the locking ratchet 135b-2 being positioned between the pair of ratchet gears 135b-1. Furthermore, the operation knob 136 includes the second pawl 136b mounted such that the second pawl 136b passes through the front upper side of the operation knob 136, the second pawl 136b being mounted such that the second pawl 136b passes through the center of the first pawl 136a, and the second pawl 136b corresponding to the locking ratchet 135b-2.

In addition, the second pawl 136b is mounted on the front upper side of the operation knob 136 such that the second pawl 136b passes through the operation knob 136, is hinge-coupled to the operation knob 136 such that the second pawl 136b is capable of being rotated by a hinge shaft, and is mounted such that the rear side of the second pawl 136b is elastically supported in the upward direction. Furthermore, a lower end of the front side of the second pawl 136b is in close contact with the upper surface of the ratchet plate 135b, the second pawl 136b corresponds to the locking ratchet 135b-2 and is engaged with or released from the locking ratchet 135b-2. At this time, the operation knob 136 includes a second spring (not illustrated) for supporting the rear side of the second pawl 136b in the upward direction. Furthermore, the second spring has a lower portion supported by the upper surface of the operation knob 136, and has an upper portion in close contact with the lower surface of the rear side of the second pawl 136b, thereby elastically supporting the rear side of the second pawl 136b in the upward direction.

In addition, the second pawl 136b has been described previously as being hinge-coupled through the upper front side of the operation knob 136. That is, as illustrated in the drawings, the second pawl 136b is hinge-coupled to the operation knob 136 by passing through the front side of the first pawl 136a such that the second pawl 136b is capable of being rotated by the hinge shaft so that the second pawl 136b is capable of being locked on or being released from the locking ratchet 135b-2 which protrudes and which is positioned between the pair of ratchet gears 135b-1.

That is, the first pawl 136a and the second pawl 136b are hinge-coupled to the operation knob 136 by using the same hinge shafts, and the first spring and the second spring are capable of being mounted on positions that do not overlap each other since a rear length of the second pawl 136b is formed to be relatively smaller than a rear length of the first pawl 136a, so that the rear side of the first pawl 136a and the rear side of the second pawl 136b are capable of being smoothly and elastically supported in the upward direction.

In addition, when a worker couples and fixes a work object or a tip tool to the hook assembly 177, the work object or the tip tool may be solidly fixed to the hook assembly 177 by simply performing work in which the operation knob 136 is moved in the rear direction. Furthermore, in a state in which the first pawl 136a is released from the ratchet gear 135b-1 by pressing the rear side of the first pawl 136a, when the operation knob 136 is moved in the front direction, the second pawl 136b is locked on the locking ratchet 135b-2, so that a two-stage movement operation is capable of being performed. Therefore, the worker may more easily and conveniently move the hook assembly 177 to a stable position, so that a state in which the work object or the tip tool is more safely held may be maintained.

In addition, after work is finished, the worker may presses the rear side of the second pawl 136b so as to separate the work object or the tip tool from the hook assembly 177, and moves the operation knob 136 in the front direction while the second pawl 136b is released from the locking ratchet 135b-2, so that the hook assembly 177 protrudes toward the front side of the holder part 167, thereby being capable of more safely and conveniently separating the work object or the tip tool from the hook assembly 177.

In relation with the description mentioned above, in the method for operating the indirect hot-line tool mechanism using the electrically insulating rotary grip-all clamp stick having the double pawl operation unit for indirect hot-line work according to the present disclosure, the electrically insulating rotary grip-all clamp stick having the double pawl operation unit for indirect hot-line work being configured such that a work object is clamped by using the hook assembly 177 inserted into the holder part 167 or the clamped work object is rotated by rotating the holder part 167 by using the electric handle 155 connected to the holder part 167 through the insulating rod part 110 includes: the operation rod 125 mounted such that the operation rod 125 passes through the hollow of the insulating rod part 110, the operation rod 125 being mounted such that the front side of the operation rod 125 is connected to the rear side of the hook assembly 177; and the double pawl operation unit 135 mounted on the rear side of the insulating rod part 110, the double pawl operation unit 135 being mounted such that the double pawl operation unit 135 is connected to the rear side of the operation rod 125, and the double pawl operation unit 135 being configured to adjust the depth at which the hook assembly 177 is inserted into the holder part 167. Furthermore, the double pawl operation unit 135 is configured such that the two-stage movement operation in the front direction with respect to the stick is capable of being formed after the operation knob 136 is pulled and moved to the rear direction without pressing the rear sides of the first pawl 136a and the second pawl 136b. Furthermore, the two-stage movement includes a first-stage movement in which the rear side of the first pawl 136a is pressed, and the operation knob 136 is moved in the front direction, and then the lower end of the front side of the second pawl 136b is locked on the locking ratchet 135b-2 such that the double pawl operation unit 135 is moved only to a state in which the hook 188 is not opened. Furthermore, the two-stage movement includes a second-stage movement in which the rear side of the second pawl 136b is pressed after the first-stage movement, and the operation knob 136 is moved in the front direction, and then the hook 188 is moved such that the hook 188 is opened. Furthermore, the depth at which the hook assembly 177 is inserted into the holder part 167 is adjusted according to the two-stage movement operation.

That is, the method for operating the indirect hot-line tool mechanism using the electrically insulating rotary grip-all clamp stick having the double pawl operation unit for indirect hot-line work according to the present disclosure may be all methods related to the operation according to the organic connection of all configurations described above. Furthermore, the reason why a separate description of the all methods are not described in detail is because the operation method is already described when the configurations above are described.

In addition, the method for performing indirect hot-line work using the electrically insulating rotary grip-all clamp stick having the double pawl operation unit for indirect hot-line work includes: the first preparation process S10 in which the electrically insulating rotary grip-all clamp stick for indirect hot-line work as described above is prepared; the second preparation process S20 in which a tip tool or a work object that is required for performing indirect hot-line work is coupled to the hook assembly 177; the work performing process in which the electric handle 155 is operated so that the holder part 167 is rotated, thereby rotating the work object that is clamped; and a disassembling process S40 in which the tip tool or the work object required for performing hot-line work is separated from the hook assembly 177 after performing the work.

At this time, the second preparation process S20 includes a retraction process S22 in which the work object required for performing the indirect hot-line work or the tip tool is hung on the hook assembly 177 that is the hook 188 and then is fixed by moving the operation knob 136 in the rear direction, and includes a fixing process S24 in which the operation knob 136 is moved in the front direction while the first pawl 136a is in a state in which the rear side of the first pawl 136a is pressed, and the operation knob 136 is moved until the second pawl 136b is locked on the locking ratchet 135b-2.

That is, in the second preparation process S20, there is an effect that the work object or the tip tool is capable of being more conveniently coupled to and fixed to the hook assembly 177 by the simple operation in which the operation knob 136 is retracted and then is moved to the front direction.

In addition, the method for performing indirect hot-line work using the electrically insulating rotary grip-all clamp stick having the double pawl operation unit for indirect hot-line work includes the disassembling process S40 in which the tip tool or the work object for performing the indirect hot-line work is separated from the hook assembly 177 after the work performing process S30.

In the disassembling process S40, the operation knob 136 is moved in the front direction while the second pawl 136b is in the state in which the rear side of the second pawl 136b is pressed, thereby separating the work object for performing the indirect hot-line work or the tip tool from the hook assembly 177 that is the hook 188. That is, as the operation knob 136 is moved to the frontmost side, the hook assembly 177 protrudes from the holder part 167, so that the work object for performing the indirect hot-line work or the tip tool is separated from the hook 188, thereby finishing the work.

The foregoing is specific description of the technical features of the present disclosure for the preferred embodiments of the present disclosure. In addition, those skilled in the art will appreciate that various modifications, additions and substitutions are possible, without departing from the scope and spirit of the present disclosure.

1.-11. (canceled)

12. An electrically insulating rotary grip-all clamp stick having a double pawl operation unit for indirect hot-line work, the clamp stick being configured to clamp a work object by using a hook assembly inserted into a holder part or being configured to rotate the clamped work object by rotating the holder part by using an electric handle connected to the holder part through an insulating rod part, the clamp stick comprising:
an operation rod mounted such that the operation rod passes through a hollow of the insulating rod part, the operation rod being mounted such that a front side of the operation rod is connected to a rear side of the hook assembly; and
the double pawl operation unit mounted on a rear side of the insulating rod part, the double pawl operation unit being mounted such that the double pawl operation unit is connected to a rear side of the operation rod, and the double pawl operation unit being configured to adjust a depth at which the hook assembly is inserted into the holder part.

13. The clamp stick of claim 12, wherein the double pawl operation unit comprises:
an extension rod part mounted on the rear side of the insulating rod part, the extension rod part having a hollow;
an operation knob having a hollow, the operation knob being mounted on an outer circumference of the extension rod part such that the operation knob is capable of being moved in front and rear directions;
a lower rack gear having a length in the front and rear directions, the lower rack gear being mounted in the hollow of the extension rod part, and the lower rack gear being mounted such that the lower rack gear is connected to the rear side of the operation rod;
a pinion part mounted on a rear side of the extension rod part, the pinion part being mounted in the hollow of the operation knob, having a hollow formed such that a rear side of the lower rack gear passes therethrough, and having a pinion gear which corresponds to the lower rack gear and which is provided on an upper portion of the lower rack gear; and
an upper rack gear having a length in the front and rear directions, the upper rack gear being fixedly mounted in the hollow of the operation knob, being fixedly mounted such that the upper rack gear is positioned on an upper portion of the pinion part, corresponding to the pinion gear, and being configured to be moved in a direction same as a movement direction of the lower rack gear by the pinion gear.

14. The clamp stick of claim 13, wherein the double pawl operation unit comprises a ratchet plate fixedly mounted on the outer circumference of the extension rod part, the ratchet plate being fixedly mounted such that the ratchet plate is positioned on a lower portion of the upper rack gear, and the ratchet plate having a pair of ratchet gears formed on an upper surface of the ratchet plate along the front and rear directions such that the ratchet gears are positioned on opposite sides of the upper rack gear, and
wherein the operation knob comprises a first pawl mounted such that the first pawl passes through an upper front side of the operation knob, the first pawl being mounted such that the first pawl corresponds to the ratchet gears.

15. The clamp stick of claim 14, wherein the pinion part comprises:
a body coupled to the rear side of the extension rod part, the body having an open upper portion of an outer circumference thereof, and the body having a hollow such that the rear side of the lower rack gear passes therethrough; and
a pair of pinion support bodies formed on opposite sides of the open upper portion of the body, the pinion support bodies being provided such that the pinion gear is capable of being rotated.

16. The clamp stick of claim 15, wherein the upper rack gear comprises a guide groove formed in a longitudinal direction on both side surfaces of the upper rack gear, and the pinion support bodies of the pinion part comprises respective guide protrusions which protrude on upper inner side surfaces of the pinion support bodies and which are inserted into the guide groove.

17. The clamp stick of claim 16, wherein the pinion part comprises a bearing part mounted in a lower portion of the hollow of the body, thereby supporting a lower surface of the lower rack gear.

18. The clamp stick of claim 14, wherein the ratchet plate comprises a locking ratchet formed on a front side of the upper surface of the ratchet plate and formed between the pair of ratchet gears, and the operation knob comprises a second pawl mounted such that the second pawl passes through the upper front side of the operation knob, the second pawl being mounted such that the second pawl passes through a center of the first pawl, and the second pawl corresponding to the locking ratchet.

19. The clamp stick of claim 12, wherein the insulating rod part comprises:
a rotating pipe having a hollow, the rotating pipe being mounted on an outer circumference of the operation rod, and the rotating pipe being mounted such that a front side of the rotating pipe is connected to a rear side of the holder part; and
a support pipe body having a hollow, the support pipe body being mounted on an outer circumference of the rotating pipe, and the support pipe body being mounted such that the holder part is connected to a front side of the support pipe body so that the holder part is capable of being rotated, and
wherein the electric handle comprises:
a power transmission part mounted between a rear side of the support pipe body and a front side of the double pawl operation unit, the power transmission part being mounted such that a power is capable of being transmitted between the rotating pipe and the electric handle, and the power transmission part being configured such that the power transmission part passes through the rear side of the operation rod;
a handle body mounted on an upper portion of the power transmission part and provided with a driving motor; and
a rotation prevention member mounted inside the power transmission part, the rotation prevention member being configured to prevent a rotation of the rotating pipe when the handle body is separated from the power transmission part.

20. The clamp stick of claim 19, wherein the power transmission part comprises:
a gear housing mounted between the rear side of the support pipe body and the front side of the double pawl operation unit;
a first bevel gear mounted on a front inner side of the gear housing and connected to a rear side of the rotating pipe; and
a second bevel gear mounted on an upper inner side of the gear housing, the second bevel gear corresponding to the first bevel gear, and the second bevel gear having a coupling hole formed through the second bevel gear, and
wherein the rotation prevention member comprises:
a lower support body mounted on a lower inner side of the gear housing; and
an upper support body mounted on an upper portion of the lower support body such that the upper support body is elastically supported in an upward direction, the upper support body being provided with a rotation prevention protrusion which is inserted into the coupling hole of the second bevel gear and which is configured to prevent a rotation of the second bevel gear.

21. A method for operating an indirect hot-line tool mechanism using an electrically insulating rotary grip-all clamp stick having a double pawl operation unit for indirect hot-line work, the clamp stick being configured to clamp a work object by using a hook assembly inserted into a holder part or being configured to rotate the clamped work object by rotating the holder part by using an electric handle connected to the holder part through an insulating rod part, the clamp stick comprising:
an operation rod mounted such that the operation rod passes through a hollow of the insulating rod part, the operation rod being mounted such that a front side of the operation rod is connected to a rear side of the hook assembly; and
the double pawl operation unit mounted on a rear side of the insulating rod part, the double pawl operation unit being mounted such that the double pawl operation unit is connected to a rear side of the operation rod, and the double pawl operation unit being configured to adjust a depth at which the hook assembly is inserted into the holder part,
wherein the double pawl operation unit is configured such that a two-stage movement operation in a front direction is capable of being performed after the double pawl operation unit is moved in a rear direction by only pulling an operation knob without pressing a rear side of a first pawl and a rear side of a second pawl,
wherein the two-stage movement operation is operated by performing
a first-stage movement in which the operation knob is moved in the front direction by pressing the rear side of the first pawl and then a lower end of a front side of the second pawl is locked on a locking ratchet so that the operation knob is moved only to a state in which a hook is not opened, and
a second-stage movement in which the rear side of the second pawl is pressed after the first-stage movement and then the operation knob is moved in the front direction so that the hook is opened, and
wherein the hook assembly is configured such that the depth at which the hook assembly is inserted into the holder part is adjusted according to the two-stage movement operation of the double pawl operation unit.

22. A method for performing indirect hot-line work using an electrically insulating rotary grip-all clamp stick for indirect hot-line work, the method comprising:
a first preparation process in which the electrically insulating rotary grip-all clamp stick for indirect hot-line work of claim 12 is prepared;
a second preparation process in which a tip tool or a work object required for performing indirect hot-line work is coupled to the hook assembly;
a work performing process in which the electric handle is operated so that the holder part is rotated, thereby rotating the work object that is clamped; and
a disassembling process in which the tip tool or the work object required for performing indirect hot-line work is separated from the hook assembly after the work is performed.
